(19) United States
(12) Patent Application Publication
(10) Pub. No.: US 2022/0361296 A1
(43) Pub. Date: Nov. 10, 2022

(54) METAL HEATER ASSEMBLY WITH EMBEDDED RESISTIVE HEATERS

(71) Applicant: Watlow Electric Manufacturing Company, St. Louis, MO (US)

(72) Inventors: Ashish BHATNAGAR, St. Louis, MO (US); Brent ELLIOT, Cupertino, CA (US)

(73) Assignee: Watlow Electric Manufacturing Company, St. Louis, MO (US)

(21) Appl. No.: 17/736,185

(22) Filed: May 4, 2022

Related U.S. Application Data
(60) Provisional application No. 63/183,932, filed on May 4, 2021.

(51) Int. Cl. H05B 3/12; H05B 3/06; H05B 3/56; H05B 1/02

(52) U.S. Cl. CPC H05B 3/12; H05B 3/06; H05B 3/56; H05B 1/023

(57) ABSTRACT

A metal heater includes a metal substrate with a groove, a resistive heater disposed within the groove, and a fill metal disposed over the resistive heater and substantially filling the groove, wherein the fill metal has a lower melting temperature than the metal substrate. The fill metal can be indium and a cover plate can be bonded to the metal substrate and over the indium. A method of manufacturing the metal heater and a method of operating the metal heater are also provided.

### CROSS-REFERENCE TO RELATED APPLICATIONS

This application claims priority to and the benefit of U.S. Provisional Patent Application No. 63/183,932, filed May 4, 2021. The disclosure of the above application is incorporated herein by reference in its entirety.

### FIELD

The present disclosure relates to metal heaters having heating elements embedded therein.

### BACKGROUND

The statements in this section merely provide background information related to the present disclosure and may not constitute prior art.

Metal heaters are used in a variety of applications to provide heat to a target and/or environment via resistive heating. One such resistive heater is a cartridge heater, which generally includes a resistive wire heating element wound around a ceramic core. In conventional applications, the ceramic core defines two longitudinal bores with power and terminal pins disposed therein. A first end of the resistive wire is electrically connected to one power pin and the other end of the resistive wire is electrically connected to the other power pin. The ceramic core assembly is disposed within a tubular metal sheath having an open end and a closed end, or, under some assemblies, two open ends, thus forming an annular space between the sheath and the resistive wire/core assembly. An insulative material, such as magnesium oxide (MgO) or the like, is poured into the open end of the sheath to fill the annular space between the resistive wire and the inner surface of the sheath.

The open end(s) of the sheath is sealed, for example with a potting compound and/or discrete sealing members. The sheath assembly may then be compacted or compressed, such as with swaging or by other suitable processes, to reduce the diameter of the sheath and compact and compress the MgO and at least partially crush the ceramic core, which collapses the core about the pins to ensure good electrical contact and thermal transfer. The compacted MgO provides a relatively adequate heat transfer path between the resistive wire heating element and the sheath and it also electrically insulates the sheath from the resistive wire heating element. In this manner, heat generated via the resistive wire heating element is transferred to the body of the metal heater, enabling the entire body of the metal heater to operate at a desired temperature.

Metal heater applications include thin film processing in semiconductor device manufacturing. Thin film processes such as chemical vapor deposition (CVD), physical vapor deposition (PVD), and atomic layer deposition (ALD), among others, can use metal heaters to heat the substrate being processed. Very small temperature variations, even fractions of a degree Celsius, can impact such film processing results. It is accordingly important in these applications of metal heaters that the temperature across the body of the metal heater be accurately and repeatedly controlled.

These issues related to metal heaters for use in semiconductor device manufacturing are addressed by the present disclosure.

### SUMMARY

This section provides a general summary of the disclosure and is not a comprehensive disclosure of its full scope or all of its features.

In one form of the present disclosure, a metal heater comprises a metal substrate with a groove formed therein, a resistive heater disposed within the groove, and a fill metal disposed over the resistive heater and substantially filling the groove, wherein the fill metal has a lower melting temperature than the metal substrate.

In variations of this metal heater, which may be implemented individually or in any combination: the resistive heater is selected from the group consisting of layered heaters, cable heaters, tubular heaters, cartridge heaters, and foil heaters; the resistive heater is a cartridge heater; the resistive heater is a cable heater; the substrate is formed of a metal or a metal alloy; the fill metal is indium; a cover plate is secured to the metal substrate and disposed over the fill metal; a plurality of grooves are in the substrate and a corresponding plurality of resistive heaters are disposed within the plurality of grooves; the groove defines an arcuate-shaped interior profile; a plurality of resistive heaters are disposed within a single groove; at least one spacer is disposed between adjacent resistive heaters of the plurality of resistive heaters; an amount of the fill metal is calculated based on volume change with temperature of the fill metal, a size of the resistive heater, and a size of the groove; at least one additional groove is substantially filled by the fill metal, wherein the at least one additional groove does not contain a resistive heater; and a plurality of layers of resistive heaters disposed within a corresponding plurality of grooves, wherein the fill metal is disposed over the plurality of resistive heaters and substantially fills the plurality of grooves.

According to another form of the present disclosure, a method for forming a heating element includes forming a groove in a metal substrate, placing a resistive heater into the groove, filling the groove with a molten fill metal, the molten fill metal having a lower melting temperature than the metal substrate, cooling the metal substrate and the molten fill metal such that the groove is filled with solidified fill metal and the resistive heater is embedded within the solidified fill metal, and securing a cover plate to the metal substrate over the solidified fill metal.

In variations of this method, which may be implemented individually or in any combination: the metal substrate is heated before filling the groove with molten fill metal; the metal substrate and molten fill metal are cooled to room temperature before bonding the cover plate to the metal substrate and over the solidified fill metal; securing the cover plate to the metal substrate comprises brazing or welding the cover plate to the metal substrate; and the molten fill metal is indium.

In still another form of the present disclosure a method of operating a heater comprises supplying power to a metal heater, the metal heater comprising a metal substrate with a groove formed therein, a resistive heater disposed within the groove, and a fill metal disposed over the resistive heater and substantially filling the groove, wherein the fill metal has a lower melting temperature than the metal substrate. Power to the metal heater is increased such that the resistive heater provides sufficient heat to melt the fill metal, the fill metal transitioning from a solid state to a liquid state during operation of the heater, while the metal substrate remains solid. In one variation of this method, the fill metal is indium.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a top view of a heater assembly constructed in accordance with the teachings of the present disclosure;

FIG. 2 is cross sectional view of section 2-2 in FIG. 1;

FIG. 3A shows a step of forming the heater assembly in FIG. 1;

FIG. 3B shows another step of forming the heater assembly in FIG. 1;

FIG. 3C shows still another step of forming the heater assembly in FIG. 1;

FIG. 3D shows still yet another step of forming the heater assembly in FIG. 1;

FIG. 4A is a cross-sectional view of a resistive heater disposed in one form of a rectangular-shaped groove in accordance with the teachings of the present disclosure;

FIG. 4B is a cross-sectional view of a resistive heater disposed in another form of a rectangular-shaped groove;

FIG. 5A is a cross-sectional view of a resistive heater disposed in one form of an angled groove in accordance with the teachings of the present disclosure;

FIG. 5B is a cross-sectional view of a resistive heater disposed in another form of an angled groove;

FIG. 6 is a cross-sectional view of a resistive heater disposed in a trapezoid-shaped groove in accordance with the teachings of the present disclosure;

FIG. 7A is a cross-sectional view of a resistive heater disposed in one form of an oblong-shaped groove in accordance with the teachings of the present disclosure;

FIG. 7B is a cross-sectional view of a pair of resistive heaters disposed in another form of an oblong-shaped groove;

FIG. 7C is a cross-sectional view of a pair of resistive heaters disposed in yet another form an oblong-shaped groove with a filler insert between the pair of resistive heaters;

FIG. 8 is a flow chart showing a method of making a heater according to the present disclosure; and

FIG. 9 is a cross-sectional view of another form of a heater assembly constructed in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

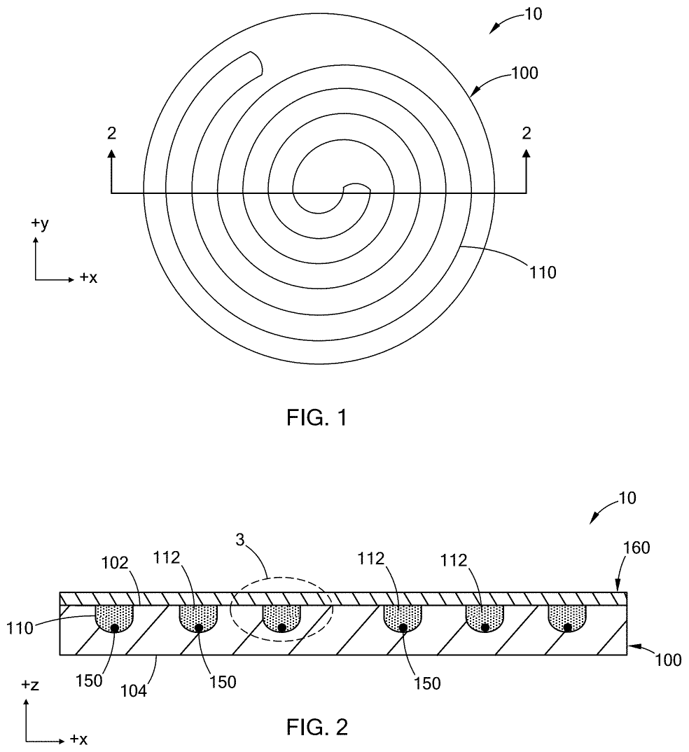

Referring now to FIGS. 1 and 2, a heater assembly 10 (e.g., a pedestal heater assembly) according to the teachings of the present disclosure is shown. The heater assembly 10 includes a substrate 100 with at least one groove 110 and a cover plate 160 (removed in FIG. 1 for purposes of clarity) secured to the substrate 100 and disposed over the groove 110. In one form, and as shown in FIG. 1, the groove 110 defines a spiral-shape as shown. In other forms, the groove 110 has a different shape, by way of example, linear, serpentine, and multiple grooves in concentric circles, among others.

Referring particularly to FIG. 2, the groove 110 extends from an upper (+z direction) surface 102 towards a lower (−z direction) surface 104 of the substrate 100, and a resistive heater 150 is disposed within the groove 110. For example, in one form, the resistive heater 150 is positioned at, or near, a bottom (−z direction) of the groove 110. However, the resistive heater 150 may be positioned at any location within the groove 110, and even protruding above the groove 110, while remaining within the scope of the present disclosure. A low melting temperature metal or alloy 112 (referred to herein simply as “fill metal 112”) is also disposed within the groove 110 and the resistive heater 150 is disposed or embedded within the fill metal 112. The cover plate 160 extends across the upper surface 102 and the groove 110 as shown. In some variations, the cover plate 160 is secured (e.g., welded or brazed) to the substrate 100. However, it should be understood that the cover plate 160 is optional.

Relative to the fill metal 112, metals and metal alloys typically melt over a temperature range. Accordingly, the phrase “melting temperature” as used herein refers the temperature range from which the fill metal 112 begins to transform from a solid to a liquid, and to the temperature at which the metal is completely liquid/molten. Therefore, the melting temperature can be a range of temperatures for the fill metal 112 and is not necessarily limited to a specific, single temperature.

Non-limiting examples of materials from which the substrate 100 and/or the cover plate 160 are made include steels, stainless steels, and aluminum alloys, among others. Also, non-limiting examples of resistive heaters 150 include cable heaters, cartridge heaters, bare wire heating elements, coil heaters, tubular heaters, layered heaters, and foil heaters, among others. Further, it should also be understood that the teachings of the present disclosure include a single resistive heater 150 as well as multiple resistive heaters 150, which may further be arranged in zones and independently controlled. Also, more than one type of resistive heater 150 may be employed in the heater assembly 10 while remaining within the scope of the present disclosure.

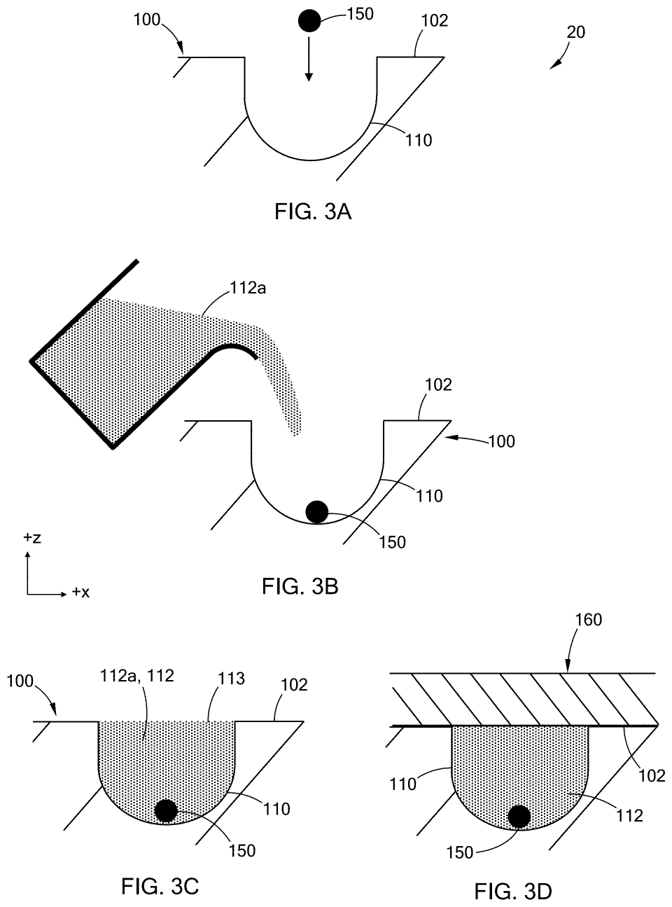

Referring now to FIGS. 3A-3D, a method 20 of forming the heater assembly 10 is shown. The method 20 includes positioning the resistive heater 150 within the groove 110 as indicated in FIG. 3A. The groove 110 may be formed according to methods known in the art, such as cutting with grooving knives, drilling, grinding, milling, and lathing, among others. And as shown in the figures, the size (e.g., diameter) of the groove 110 is larger (greater) than a diameter, or outer dimension, of the resistive heater 150. In one form of the present disclosure, the size of the of the groove 110 is at least 100% larger than a diameter of the resistive heater 150. And in at least one form, the size of the groove 110 is at least 200% larger than a diameter of the resistive heater 150, for example, about 300% larger, about 400% larger, about 500% larger, about 600% larger, about 700% larger, or about 1000% larger than the diameter of the resistive heater 150.

Referring to FIG. 3B, the method 20 includes pouring liquid fill metal 112a into the groove 110 such that an upper surface 113 of the liquid fill metal 112a is at a desired height (z direction) as shown in FIG. 3C. The method 20 also includes securing a cover plate 160 to the substrate 100 as shown in FIG. 3D. In one form, the substrate 100 with the resistive heater 150 disposed in the groove 110 is heated before pouring the liquid fill metal 112a into the groove 110. And in at least one variation, the substrate 100 with the resistive heater 150 disposed in the groove 110 is heated to a temperature that is generally equal to or greater than a melting temperature of the liquid fill metal 112a. For example, in one variation the liquid fill metal 112a is liquid indium (T(melt)≈157° C.) and the substrate 100 with the resistive heater 150 disposed in the groove 110 is heated above (i.e., greater than) 157° C. before the liquid indium is poured into the groove 110. Heating of the substrate 100 results in a volume expansion of the substrate 100 and an expansion of the volume (and size) of the groove 110. Accordingly, when the groove 110 filled with the liquid fill metal 112a cools, solidification shrinkage of the liquid fill metal 112a is at least partially accommodated for by the volume shrinkage of the substrate 100.

In one form, the groove 110 is filled with the liquid fill metal 112a such that the upper surface 113 of the liquid fill metal 112a is generally equal in height (z direction) or on the same plane (x-y plane) as the upper surface 102 of the substrate 100. Also, the liquid fill metal 112a solidifies such that the resistive heater 150 is embedded within the fill metal 112. The resistive heater 150 may be completed encased by, or embedded within the fill metal 112, or partially encased by or embedded within the fill metal 112.

It should be understood that the fill metal 112 functions as an enhanced heat transfer medium compared to physical contact between the resistive heater 150 and the substrate 100. For example, a heater assembly with a heating element disposed in a groove of generally the same size, can result in gaps/voids (e.g., air gaps) between the heating element and the substrate along a length of the heating element. Also, such gaps result in reduced heat transfer between the heating element and the substrate such that undesirable non-uniform heating of the substrate occurs. In contrast, pouring the liquid fill metal 112a into the groove 110 and onto the resistive heater 150 provides direct and intimate contact between the resistive heater 150 and the fill metal 112, and thus between the fill metal 112 and the substrate 100. That is, the fill metal 112 enhances metal-to-metal contact between the resistive heater 150 and the substrate 100 without the presence of gaps. Accordingly, enhanced heat transfer and enhanced heat transfer uniformity is provided by the heater assembly 10 according to the teachings of the present disclosure, which is further described in greater detail below.

Non-limiting examples of the fill metal 112 include indium (T(melt)≈157° C.), tin (T(melt)≈232° C.), zinc (T(melt)≈420° C.), and alloys thereof, among others. It should be understood that the liquid fill metal 112a typically exhibits a volume reduction (shrinkage) during solidification. For example, indium exhibits a solidification shrinkage of about 4 volume percent. It should also be understood that such solidification shrinkage is accounted for during pouring of the liquid fill metal 112a into the groove such that the upper surface 113 of the fill metal 112 is at a desired height (z direction) relative to the upper surface 102 of the substrate 100. In some variations, the solidification shrinkage of the liquid fill metal 112a is accounted for such that the upper surface 113 is generally planar with the upper surface 102 of the substrate 100. In other variations, the solidification shrinkage of the liquid fill metal 112a is accounted for such that the upper surface 113 of the fill metal 112 is below (−z direction) the upper surface 102 of the substrate 100 a predefined distance. And in at least one variation, the solidification shrinkage of the liquid fill metal 112a is accounted for such that the upper surface 113 of the fill metal 112 is above (+z direction) the upper surface 102 of the substrate 100 a predefined distance. In such a variation the upper surfaced 113 can be lowered (−z direction) via grinding such that a planar surface across the upper surface 102 of the substrate and the fill metal 112 is provided.

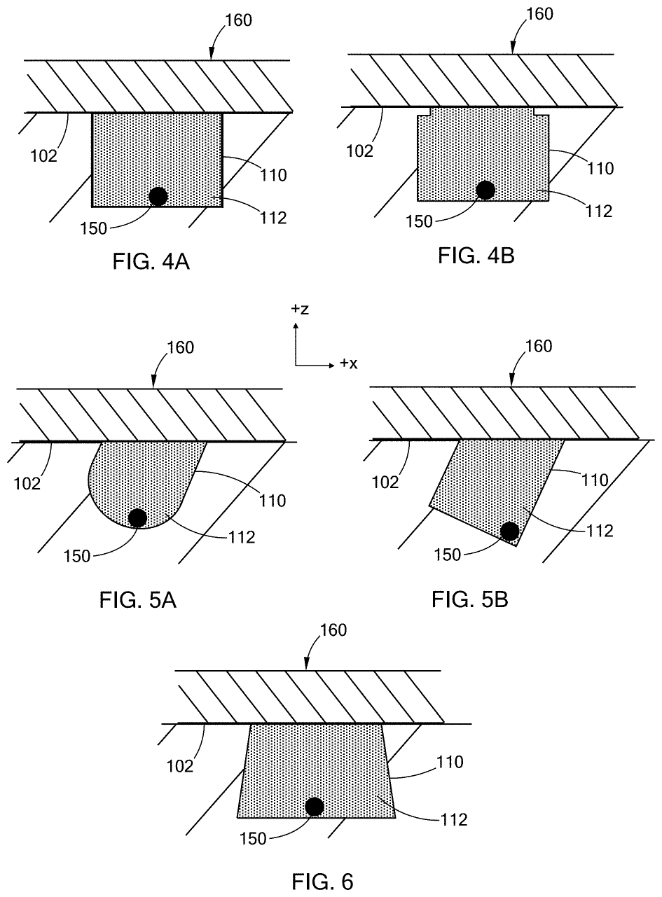

While FIGS. 2 and 3A-3D show the groove 110 with an arcuate-shaped interior profile (e.g., circular- or semi-circular-shaped interior profile), heater assemblies with grooves having interior profiles with other shapes are included in the teachings of the present disclosure. For example, FIGS. 4A-4B show examples of rectangular-shaped grooves 110 with the resistive heater 150 positioned at the bottom of, and the fill metal 112 is disposed within, the rectangular-shaped grooves 110.

Referring to FIGS. 5A-5B, angled grooves 110 are shown with the resistive heater 150 positioned at the bottom of, and the fill metal 112 is disposed within, the angled grooves 110.

Referring to FIG. 6, a trapezoid-shaped groove 110 is shown with the resistive heater 150 positioned at the bottom of, and the fill metal 112 is disposed within, the trapezoid-shaped grooves 110.

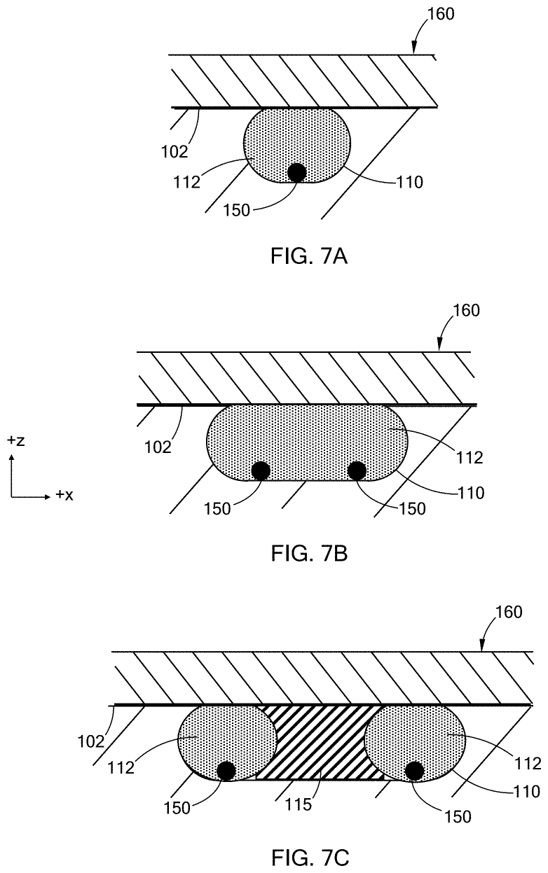

Referring to FIGS. 7A-7C, oblong-shaped grooves 110 are shown. In FIG. 7A the resistive heater 150 is positioned at the bottom of, and the fill metal 112 is disposed within, the oblong-shaped groove 110. In FIGS. 7B and 7C, a pair of resistive heaters 150 are positioned at the bottom of the oblong-shaped groove 110 and liquid fill metal 112a is poured into the oblong-shaped groove to form the fill metal 112. In the variation shown in FIG. 7C, a spacer or insert 115 is placed in the oblong-shaped groove 110 between the pair of resistive heaters 150 and the liquid fill metal 112a is poured into two separate cavities between the insert 115 and the interior surface of the groove 110. Therefore, a plurality of resistive heaters 150 may be placed into a single groove 110, with or without a spacer, or spacers, according to the teachings of the present disclosure. It should also be understood that the resistive heater 150 need not be at the bottom of the groove 110 as illustrated herein, and instead may be held in position at any location within the groove 110 while the liquid fill metal 112a is poured into the groove(s) 110.

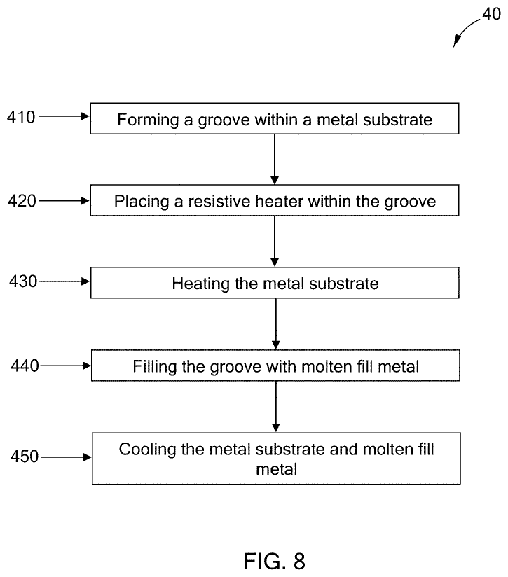

Referring to FIG. 8, a method 40 for forming a heater (such as heater assembly 10) includes forming a groove (such as groove 110) in a metal substrate (such as substrate 100) at 410 and placing a resistive heater (such as resistive heater 150) into the groove at 420. At 430, the metal substrate is heated, for example to greater than or equal to about 157° C. when a fill metal is indium, and at 440 the groove is filled with the molten fill metal. At 450, the metal substrate and molten fill metal are cooled to room temperature to solidify the molten fill metal. A cover plate may afterwards be affixed to the metal substrate (not shown). Alternately, the fill metal may be used to fill an existing groove without a cover plate. In this case, the groove would be disposed or embedded within the metal substrate, and the end(s) of the groove would be sealed after filling the groove. These and other variations should be construed as falling within the scope of the present disclosure.

According to another form of the present disclosure, a method of operating the heater assembly 10 (also referred to herein as the “metal heater”) includes supplying power to the metal heater 10, increasing the power such that the resistive heater 150 provides sufficient heat to melt the fill metal 112, the fill metal 112 transitioning from a solid state to a liquid state during operation of the heater 10, while the metal substrate 100 remains solid. Therefore, during operation of the heater assembly 10, the fill metal 112 is molten and thus fills in any voids and expands in volume to improve heat transfer from the resistive heater 150 to the metal substrate 100.

It should be understood that the fill metal 112 need not necessarily completely fill the groove 110 while remaining within the scope of the present disclosure. Based on the material properties of the fill metal 112, a volume change with temperature can be calculated such that the volume during operation is sufficient to fully encase, or to sufficiently encase for improved heat transfer, the resistive heater 150. With this approach, the volume change with temperature of the fill material 112, the size of the resistive heater 150, and the size of the groove 110 would be taken into account to calculate the amount of fill metal 112 needed to sufficiently encase the resistive heater 150 during operation. Alternately, for a fixed volume of fill metal 112, the size of the groove 110 can be calculated to sufficiently encase the resistive heater 150.

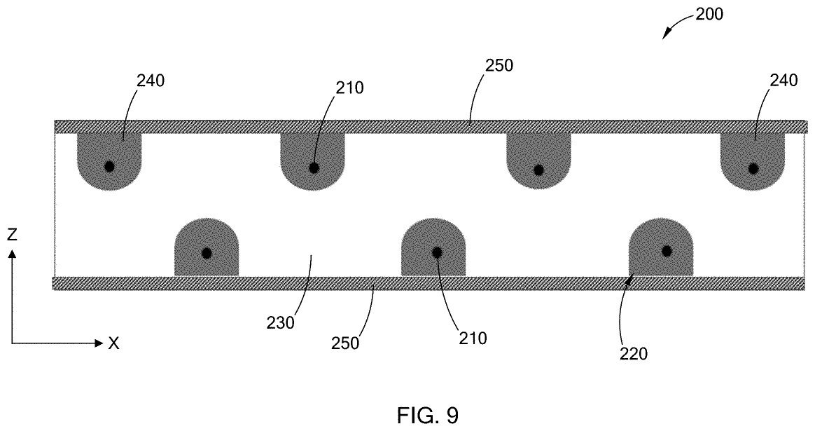

Referring now to FIG. 9, another form of a metal heater is illustrated and generally indicated by reference numeral 200. In this form, a plurality of “layers” of embedded resistive heaters 210 are disposed within grooves 220 of a metal substrate 230 (or plurality of separate substrates that are joined together, not shown). The metal heater 200 also includes a fill metal 240 as previously described, which has a lower melting temperature than the metal substrate 230. In this form, the layers of resistive heaters 210 are arranged in a staggered configuration along the X-axis and are layered along the Z-axis as shown in order to provide improved temperature uniformity. It should be understood that this arrangement of resistive heaters 210 and grooves 220 is merely exemplary, and thus any number of layers and locations of resistive heaters 210 and grooves 220 may be implemented while remaining within the scope of the present disclosure. Further, the metal heater 200 generally may include any of the features as set forth above, individually or in any combination, while remaining within the scope of the present disclosure. For example, in this form, cover plates 250 are provided on both the top and bottom of the metal heater 200.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Specially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

As used herein, the phrase at least one of A, B, and C should be construed to mean a logical (A OR B OR C), using a non-exclusive logical OR, and should not be construed to mean “at least one of A, at least one of B, and at least one of C.”

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A metal heater comprising:
a metal substrate with a groove formed therein;
a resistive heater disposed within the groove; and
a fill metal disposed over the resistive heater and substantially filling the groove, wherein the fill metal has a lower melting temperature than the metal substrate.

2. The metal heater according to claim 1, wherein the resistive heater is selected from the group consisting of layered heaters, cable heaters, tubular heaters, cartridge heaters, and foil heaters.

3. The metal heater according to claim 1, wherein the resistive heater is a cartridge heater.

4. The metal heater according to claim 1, wherein the resistive heater is a cable heater.

5. The metal heater according to claim 1, wherein the metal substrate is formed of a metal or a metal alloy.

6. The metal heater according to claim 1, wherein the fill metal is indium.

7. The metal heater according to claim 6, further comprising a cover plate secured to the metal substrate and disposed over the fill metal.

8. The metal heater according to claim 1, further comprising a plurality of grooves and a corresponding plurality of resistive heaters disposed within the plurality of grooves.

9. The metal heater according to claim 1, wherein the groove defines an arcuate-shaped interior profile.

10. The metal heater according to claim 1, further comprising a plurality of resistive heaters disposed within a single groove.

11. The metal heater according to claim 10, further comprising at least one spacer disposed between adjacent resistive heaters of the plurality of resistive heaters.

12. The metal heater according to claim 1, wherein an amount of the fill metal is calculated based on volume change with temperature of the fill metal, a size of the resistive heater, and a size of the groove.

13. The metal heater according to claim 1, further comprising at least one additional groove substantially filled by the fill metal, wherein the at least one additional groove does not contain a resistive heater.

14. The metal heater according to claim 1, further comprising a plurality of layers of resistive heaters disposed within a corresponding plurality of grooves, wherein the fill metal is disposed over the plurality of resistive heaters and substantially fills the plurality of grooves.

15. A method for forming a heating element, the method comprising:
forming a groove in a metal substrate;
placing a resistive heater into the groove;
filling the groove with a molten fill metal, the molten fill metal having a lower melting temperature than the metal substrate;
cooling the metal substrate and the molten fill metal such that the groove is filled with solidified fill metal and the resistive heater is embedded within the solidified fill metal; and
securing a cover plate to the metal substrate over the solidified fill metal.

16. The method according to claim 15, further comprising heating the metal substrate before filling the groove with molten fill metal.

17. The method according to claim 15, wherein the metal substrate and molten fill metal are cooled to room temperature before bonding the cover plate to the metal substrate and over the solidified fill metal.

18. The method according to claim 15, wherein bonding the cover plate to the metal substrate comprises brazing or welding the cover plate to the metal substrate.

19. The method according to claim 15, wherein the molten fill metal is indium.

20. A method of operating a heater, the method comprising:
supplying power to a metal heater, the metal heater comprising:
a metal substrate with a groove formed therein;
a resistive heater disposed within the groove; and
a fill metal disposed over the resistive heater and substantially filling the groove, wherein the fill metal has a lower melting temperature than the metal substrate; and
increasing the power such that the resistive heater provides sufficient heat to melt the fill metal, the fill metal transitioning from a solid state to a liquid state during operation of the heater, while the metal substrate remains solid.

21. The method according to claim 20, wherein the fill metal is indium.
